(19) United States
(12) Patent Application Publication
(10) Pub. No.: US 2026/0310567 A1
(43) Pub. Date: Oct. 8, 2026

(54) FAULT TREE GENERATING DEVICE AND METHOD FOR GENERATING FAULT TREE USING THE SAME

(71) Applicant: KOREA ATOMIC ENERGY RESEARCH INSTITUTE, Daejeon (KR)

(72) Inventors: Ho-Gon LIM, Sejong-si (KR); Sang-Hoon HAN, Daejeon (KR)

(21) Appl. No.: 18/996,808

(22) PCT Filed: Jun. 12, 2023
(86) PCT No.: PCT/KR2023/008046

§ 371 Date: Jan. 17, 2025

(51) Int. Cl. G06F 11/22

(52) U.S. Cl. CPC G06F 11/2252

(57) ABSTRACT

The present invention relates to a fault tree generating device for generating a final fault tree by generating a fault tree based on a resource flow diagram, but extracting fault tree composition items for each layer along a flow line of the resource flow diagram to sequentially generate the fault tree according to the layer, and a method for generating a fault tree using the same. To this end, a fault tree generating device that generates a fault tree based on a resource flow diagram composed of a plurality of components includes a control unit that generates a final fault tree by extracting fault tree composition items including an input start point, an output arrival point, a simple component, and a complex component based on the received resource flow diagram, and connecting the fault tree composition items according to a layer to sequentially generate fault trees.

### TECHNICAL FIELD

The following disclosure relates to a fault tree generating device and a method for generating a fault tree using the same, and more particularly, to a fault tree generating device for generating a final fault tree by generating a fault tree based on a resource flow diagram, extracting fault tree composition items for each layer along a flow line of the resource flow diagram to sequentially generate the fault tree according to the layer, and a method for generating a fault tree using the same.

### BACKGROUND

In general, a fault tree is a method of deductively tracking failure scenarios and events. Previously, fault tree developers review the corresponding resource supply (coolant, electricity, signals, etc.) system pipe and instrumentation diagram (P&ID), remove parts unrelated to success/failure according to the overall success/failure conditions of the system, and then produce a core simple resource flow diagram, and analysts convert the produced resource flow diagrams into the fault tree by hand.

Accordingly, it takes a lot of time to write and has the disadvantage that errors due to illusory errors can often occur, especially in distinguishing between success and failure.

In addition, the writing of the existing fault tree generally has limitations in expressing failures in components of a system. For example, pumps or valves, which are frequently considered in a fluid flow diagram, are major components of the system. In the case of these component failures, the same logic may be expressed in very different ways depending on the developer expressing the component failures.

The expressions of the valve failure include events such as (1) failure to start, (2) failure to run, (3) common cause failure, (4) electrical support failure, (5) cooling failure, and (6) signal failure. There are many different ways to express these failures. Since these various types of failures are not standardized, there may be a lack of consistency in the writing and review process, and the possibility of errors may increase.

In addition, circular logic may occur in large fault trees. In a system that is assisted by electricity or cooling to perform a specific function, this assistance relationship is reversed and occurs, causing various problems in creating the fault tree.
(Patent Document 1) Korean Patent Laid-Open Publication No. 10-2018-0046524 (Publication Date: May 9, 2018)

### Technical Problem

An embodiment of the present disclosure is directed to providing a fault tree generating device capable of improving intuitive understanding, dramatically reducing time and errors in fault tree development, and automatically generating a fault tree using a resource flow diagram, by extracting a fault tree composition item based on a resource flow diagram and generating a fault tree sequentially according to a layer of the fault tree composition item to generate a final fault tree, and a method for generating a fault tree using the same.

### Technical Solution

The present invention (disclosure) has the following features to solve the above problems.

In one general aspect, a fault tree generating device that generates a fault tree based on a resource flow diagram composed of a plurality of components includes a control unit that generates a final fault tree by extracting fault tree composition items including an input start point, an output arrival point, a simple component, and a complex component based on the received resource flow diagram, and connecting the fault tree composition items according to a layer to sequentially generate fault trees.

The control unit may generate a fault tree of a first layer in which the fault tree composition items are connected in series along the flow line of the resource flow diagram, and generate a fault tree of a second layer by primarily decomposing the complex component into a configuration of a plurality of simple components or lower complex components branched when there is the composite component among the fault tree composition items constituting the fault tree of the first layer.

When there is the lower complex component among the fault tree composition items constituting the fault tree of the second layer, the control unit may generate a fault tree of an Nth layer by secondarily decomposing the lower complex component into the configuration of the plurality of simple components or lower complex components branching along the flow line of the resource flow diagram but (N−1)-order decomposing the lower complex component until the fault tree composition item is composed of only the plurality of simple components. (Here, N is a natural number, and 3≤N.)

The control unit may include an item extraction unit that extracts the fault tree composition items for each layer based on the received resource flow diagram, and a fault tree generation unit that generates the final fault tree by sequentially generating fault trees for each layer based on the resource flow diagram and the fault tree composition items for each layer.

The complex component may include the plurality of simple components or lower complex components branched and configured along the flow line of the resource flow diagram, and the lower complex component may be included as a fault tree composition item in an upper complex component, and the plurality of simple components or lower complex components may be included as a fault tree composition item therein.

The fault tree generation unit may arrange the output arrival point, which is the last point reached along the flow line of the resource flow diagram, at a top when configuring the fault tree of the first layer, arrange the input start point, which is the start point on the flow line of the resource flow diagram and the simple component or the complex component connected in series to be spaced apart from each other to left and right on a lower side of the output arrival point, respectively, and connect the simple component or the complex component so that the output arrival point receives failure information from the input start point, the simple component, or the complex components.

In the case where there is the complex component in the fault tree of the first layer when configuring the fault tree of the second layer, the fault tree generation unit may arrange the simple component or the lower complex component included in the complex component to the left and right on the lower side of the complex component, and connect the simple component or the lower complex component to receive the failure information from the simple component or the lower complex component.

In the case where there is the lower complex component in the fault tree of the (N−1)th layer when configuring the fault tree of the Nth layer, the fault tree generation unit may arrange the simple component or the lower complex component included in the lower complex component to the left and right on the lower side of the lower complex component, and connect the simple component or the lower complex component to receive the failure information from the simple component or the lower complex component. (Here, N is a natural number, and 3≤N.)

The item extraction unit may generate a layer flow diagram that sequentially displays the fault tree composition items according to the layer based on the resource flow diagram, and the fault tree generation unit may sequentially generate fault trees for each layer based on the layer flow diagram.

The item extraction unit may display nodes for each layer between the fault tree composition items for each layer in the layer flow diagram.

The fault tree generation unit may classify the failure information of the fault tree composition item, respectively, according to the failure mode and failure type and connects the simple component to receive the failure information, the failure information according to the failure mode may include at least one of a fail to start event and a fail to run event, and the failure information according to the failure type may include at least one of failure of component itself and auxiliary system failure.

The failure information due to the failure of the component itself may include at least one of independent failure, common cause failure, and human error, and the failure information according to the auxiliary system failure may include at least one of cooling failure, electrical support failure, signal transmission failure, and other failure information according to user setting.

In another general aspect, a method for generating a fault tree includes, by the control unit, a) extracting the fault tree composition items including the input start point, the output arrival point, the simple component, and the complex component based on the received resource flow diagram, and generating the fault tree of the first layer, which is the fault tree of the serial structure, b) determining whether there is a fault tree composition item in a lower-layer layer, and c) when there is the fault tree composition item of the lower layer, decomposing the fault tree composition item to generate a fault tree of the layer, and returning to step b) above, and when there is no fault tree composition item of the lower layer, generating the fault tree of the corresponding layer as the final fault tree.

The complex component may include the plurality of simple components or lower complex components branched and configured along the flow line of the resource flow diagram, and the lower complex component may be included as a fault tree composition item in an upper complex component, and the plurality of simple components or lower complex components may be included as a fault tree composition item therein.

The control unit may include an item extraction unit that extracts the fault tree composition items for each layer based on the received resource flow diagram, and a fault tree generation unit that generates the final fault tree by sequentially generating fault trees for each layer based on the resource flow diagram and the fault tree composition items for each layer.

### Advantageous Effects

According to the present invention, by using the resource flow diagram as the interface for writing the fault tree, it is possible to improve the intuitive understanding, dramatically reduce the time and errors of the fault tree development, and automatically generate the fault tree using the resource flow diagram in the existing fault tree development by hand.

In addition, it is possible to minimize and optimize the size of the fault tree using the layer concept and eliminate the possibility of errors through the standardization of the component failure structure.

In addition, it is possible to automatically set the system mutual assistance relationships, eliminate the possibility of errors, and eliminate the circular logic relationships in the system by adding the failure information for each failure mode and failure type.

### BRIEF DESCRIPTION OF THE DRAWINGS

FIG. 1 is a diagram illustrating a fault tree generating device according to an embodiment of the present invention.

FIG. 2 is a diagram illustrating an example of a resource flow diagram.

FIG. 3 is a diagram illustrating a layer flow diagram having a second layer according to an embodiment of the present invention.

FIG. 4 is a diagram illustrating FIG. 3 as a layer flow diagram having a first layer.

FIG. 5 is a diagram illustrating a fault tree of the first layer generated based on the layer flow diagram of FIG. 4.

FIG. 6 is a diagram showing a fault tree of the second layer by decomposing composite component 1 and composite component 2 of FIG. 5.

FIG. 7 is a diagram including an additional fault tree item in FIG. 6.

FIG. 8 is a diagram illustrating a fault tree of a simple component for each failure type and failure mode of a component according to another embodiment of the present invention.

FIG. 9 is a flowchart illustrating a method for generating a fault tree according to an embodiment of the present invention.

### DETAILED DESCRIPTION OF EMBODIMENTS

In order to explain the present invention and the operational advantages of the present invention and the objects achieved by the practice of the present invention, preferred embodiments of the present invention will be exemplified below and the present invention will be described with reference thereto.

First, the terms used in this application are only used to describe specific embodiments, and are not intended to limit the present invention, and singular expressions may include plural expressions unless the context clearly indicates otherwise. It should be understood that terms “include” or “have” used in the present specification, specify the presence of features, numerals, steps, operations, components, parts mentioned in the present specification, or combinations thereof, but do not preclude the presence or addition of one or more other features, numerals, steps, operations, components, parts, or combinations thereof.

In describing exemplary embodiments of the present invention, well-known functions or constructions will not be described in detail since they may unnecessarily obscure the understanding of the present invention.

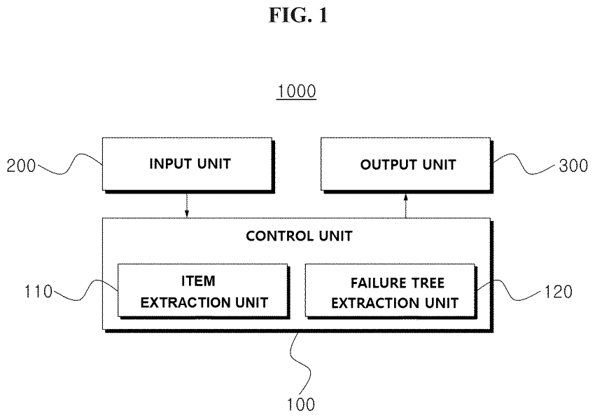

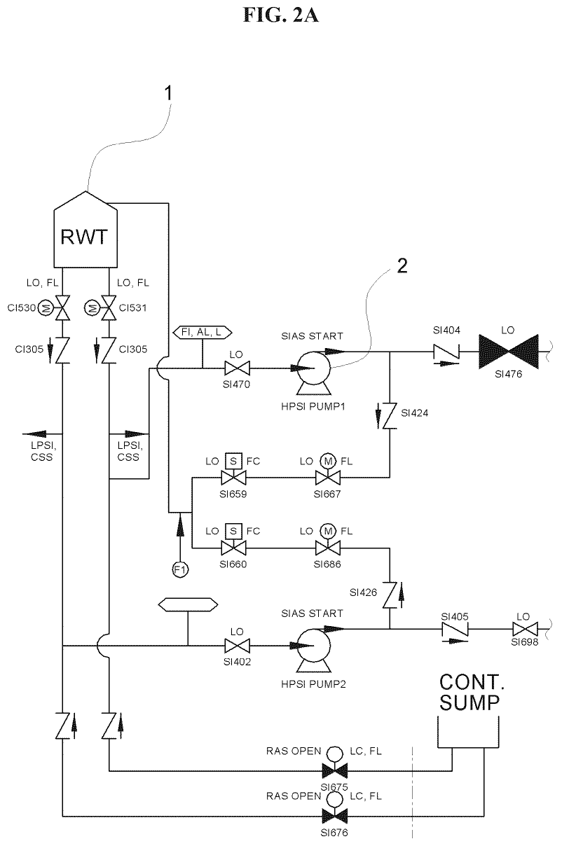

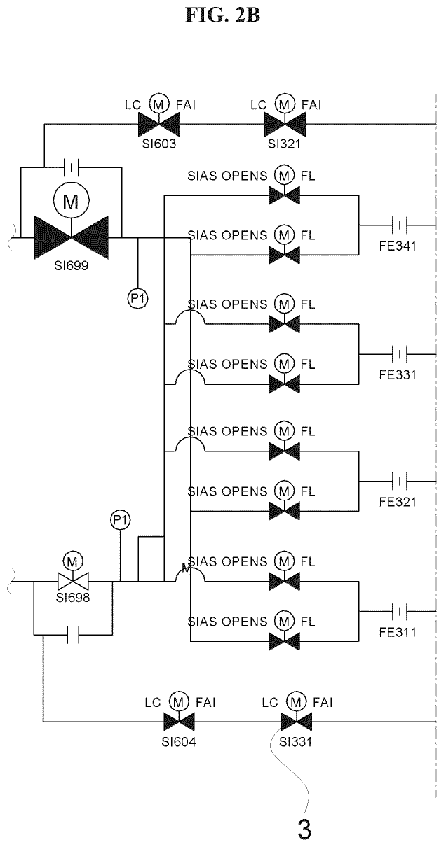

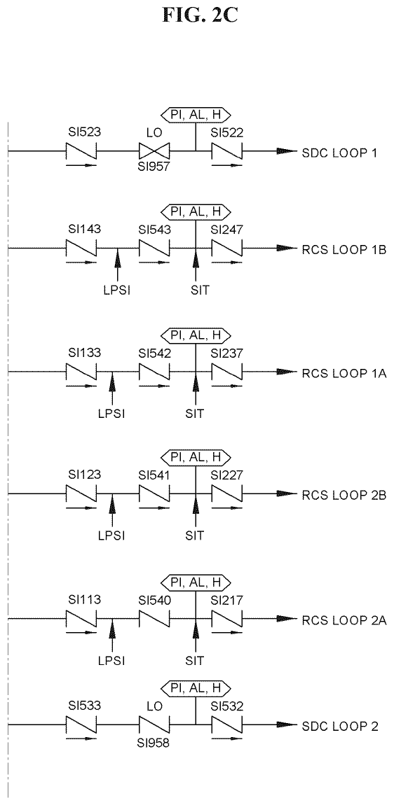

FIG. 1 is a diagram illustrating a fault tree generating device according to an embodiment of the present invention, and FIG. 2 is a diagram illustrating an example of a resource flow diagram.

Referring to the drawings, a fault tree generating device 1000 according to an embodiment of the present invention includes an input unit 200 that receives a resource flow diagram composed of a plurality of components, a control unit 100 that generates a final fault tree by extracting fault tree composition items 111 including an input start point 111a, an output arrival point 111d, a simple component 111b, and a complex component 111c based on the received resource flow diagram received from the input unit 200 and connecting the fault tree composition items 111 according to a layer to sequentially generate a fault tree, and an output unit 300 that receives the final fault tree from the control unit 100 and transmits the received final fault tree to the outside or outputs the received final fault tree through a display means.

Here, as illustrated in FIG. 2, the resource flow diagram refers to a diagram expressed using flow lines and components in which specific resources (e.g., coolant, electricity, signals, etc.) go through a processing process and are supplied to where they are needed.

FIG. 2 illustrates a resource flow diagram that supplies an emergency coolant to a nuclear power plant, and illustrates a process in which coolant is supplied from a tank 1 on the upper left through components such as a valve 3 and a pump 2 to a water supply nozzle of a reactor coolant system.

In the present invention, as the control unit 100 automatically generates the fault tree based on such a resource flow diagram, and by generating the fault tree based on this resource flow diagram, it is possible to improve intuitive understanding and shorten the fault tree generation time and errors.

Meanwhile, as described above, the control unit 100 first extracts the input start point 111a and the output arrival point 111d along the flow line in the resource flow diagram based on the received resource flow diagram, and extracts the plurality of simple components 111b and complex components 111c in the process of moving from the input start point 111a to the output arrival point 111d.

Here, the input start point 111a is the start point of the resource flow diagram and may be a resource repository such as a tank or storage battery or may be started by receiving an external output, and may be expressed in the form of the simple component.

In addition, the output arrival point 111d is a last arrival point where resources arrive in the resource flow diagram and may be an input point of a specific repository or another system. There may be two or more output arrival points 111d.

In addition, the simple component 111b refers to one individual component, and the complex component 111c refers to an aggregate of the plurality of simple components 111b connected by the flow line of the resource flow diagram.

The complex component 111c may be displayed to include a separate sub-concept of complex components, and in the present invention, the sub-concept of the complex component 111c is expressed as a layer to sequentially fault trees according to the layer, thereby generating the final fault tree.

The concept of the layer in this resource flow diagram is that, as described above in the flow of resources from the input start point 111a to the output arrival point 111d, the aggregate that may be merged into a complex component 111c first represents the layer flow diagram in a serial structure of the plurality of simple components 111b or complex components 111c, which may defined as a layer flow diagram of a first layer.

Then, when there is the complex component 111c in the first layer, the complex component 111c may be decomposed into a plurality of simple components branched into multiple numbers along the flow line in the resource flow diagram or lower complex components 111c and displayed as a layer flow diagram of a second layer.

In addition, when there is the lower complex component 111c in the layer flow diagram of the second layer, the lower complex component 111c may be decomposed again and displayed as a layer flow diagram of a third layer, and may be continuously decomposed until they are displayed only as simple components 111b, and displayed as a layer flow diagram of an Nth layer.

Here, the layer flow diagram is expressed by combining the resource flow diagram with the concept of the layer, and the control unit 100 according to the present invention sequentially displays the layer flow diagrams for each layer when generating the final fault tree, and generates the fault trees for each layer, and when the final layer is reached, generates the final fault tree.

Of course, the layer flow diagram is conceptually displayed for each layer in order for the control unit 100 to generate the final fault tree according to one embodiment of the present invention, and the present invention is not limited thereto.

In addition, in the layer flow diagram, a node 112 may be displayed to distinguish each layer and these nodes 112 are displayed as nodes in a specific layer. Since the resources between the complex components 111c or the simple components 111b are not separated, at least two nodes 112 are displayed in each layer.

The node may be displayed between the complex components 111c or the simple components 111b, and may also be displayed between the node and the complex component 111c or the node and the simple component 111b.

That is, the second layer node may be displayed between the first layer node and the fault tree composition item of the second layer.

Hereinafter, the process of generating the final fault tree by extracting, by the control unit 100, the fault tree composition items 111 for each layer and generating the layer flow diagrams for each layer will be described in more detail.

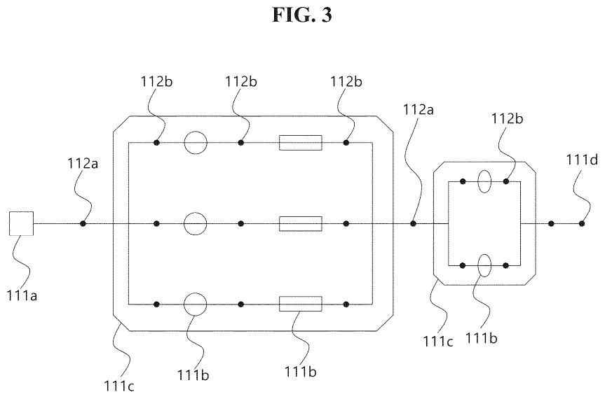

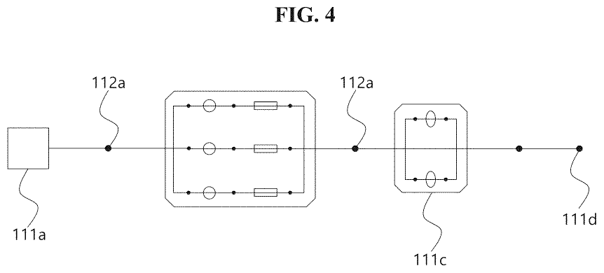

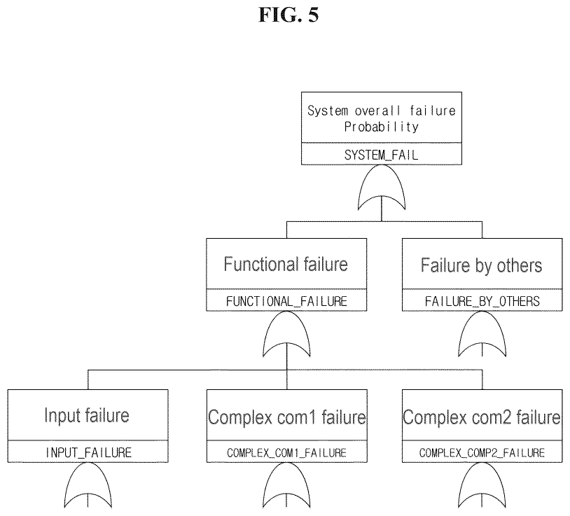

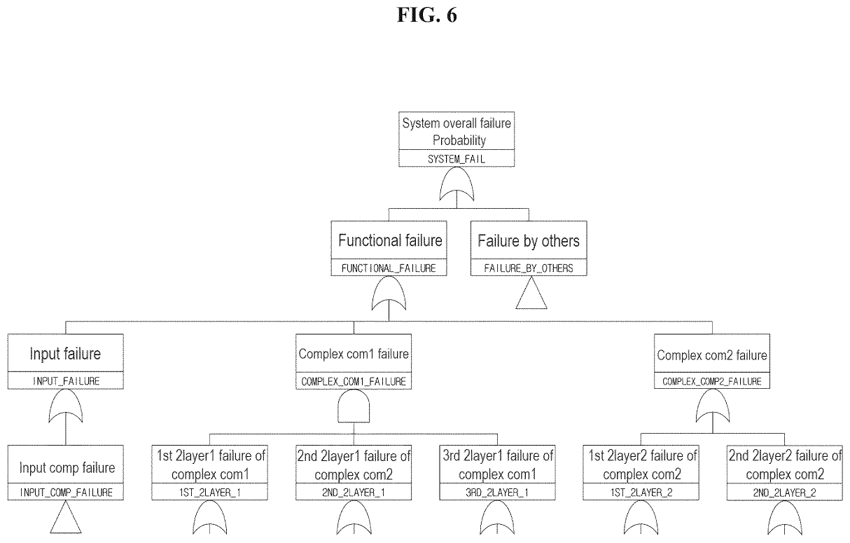

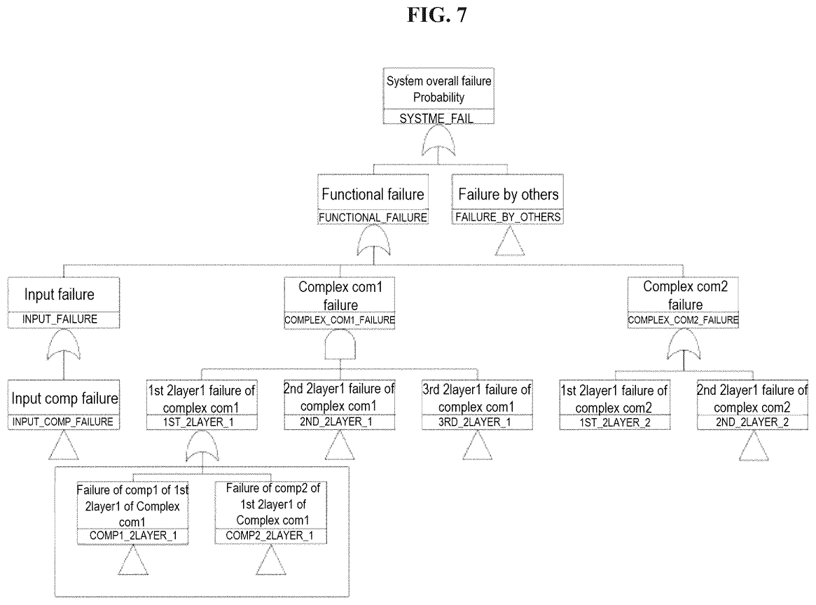

FIG. 3 is a diagram illustrating a layer flow diagram having a second layer according to an embodiment of the present invention, FIG. 4 is a diagram illustrating FIG. 3 as a layer flow diagram having a first layer, FIG. 5 is a diagram illustrating a fault tree of the first layer generated based on the layer flow diagram of FIG. 4, FIG. 6 is a diagram showing a fault tree of the second layer by decomposing composite component 1 and composite component 2 of FIG. 5, and FIG. 7 is a diagram including an additional fault tree item in FIG. 6.

Referring to the drawings, as described above, the control unit 100 of the present invention includes an item extraction unit that extracts the fault tree composition items 111 for each layer based on the received resource flow diagrams and generates the layer flow diagrams for each layer, which displays the extracted fault tree composition items 111 by connecting the extracted fault tree composition items 111 along the flow line, and a fault tree generation unit 120 that generates the final fault tree by sequentially generating the fault trees for each layer based on the resource flow diagram, the fault tree composition items 111 for each layer, and the layer flow diagram for each layer.

Here, the item extraction unit 110 extracts the fault tree composition items 111 for each layer based on the resource flow diagram. First, as illustrated in FIG. 4, the fault tree composition items 111 having the first layer in which the flow of resources is connected in the form of a serial structure from the input start point 111a to the output arrival point 111d is extracted.

Of course, in order to extract the fault tree composition item 111 having such a first layer, as illustrated in FIG. 3, the final layer flow diagram detailed for each layer is first derived based on the resource flow diagram, and thus, the layer flow diagram of the first layer is calculated and the fault trees are sequentially generated in layer order.

That is, the item extraction unit 110 according to the present invention may first extract the plurality of simple components 111b based on the resource flow diagram, merge some simple components 111b into complex components 111c along the flow line of the resource flow diagram, and sequentially merge the components 1 to N times to generate the layer flow diagram of the first layer in which the fault tree composition items 111 are displayed only in a serial structure.

Then, the fault tree generation unit 120 generates the fault tree of the first layer as illustrated in FIG. 5 based on the layer flow diagram of the first layer, and when there are the complex components 111c among the fault tree composition items 111 of the first layer, the item extraction unit 110 first decomposes the complex components 111c to generate the layer flow diagram of the second layer.

In addition, the fault tree generation unit 120 again arranges the fault tree composition items into the primarily decomposed simple components 111b or lower complex components 111c to the left and right on the lower side of the fault tree composition item for the complex component 111c in the fault tree of the first layer based on the layer flow diagram of the second layer.

The resource flow diagram in FIG. 3 is a resource flow diagram arbitrarily illustrated for the fault tree generation process. In FIG. 3, there are two complex components 111c, but the two complex components may be displayed as the simple components 111b in the second layer and thus the final fault tree has the second layer.

However, it goes without saying that these layers may be displayed from the third layer to the Nth layer when the resource flow diagram is complex.

To express this in general terms, when there is the lower complex component 111c among the fault tree composition items constituting the fault tree of the Nth layer, the fault tree generation unit 120 (N−1)-order decomposes the lower complex component 111c into a configuration of the simple component 111b or the lower complex component 111c branched along the flow line of the resource flow diagram, but (N−1)-order decomposes the lower complex component 111c until the fault tree composition item is composed of only the plurality of simple components, thereby generating the fault tree of the Nth layer. In this case, N is a natural number, and 3≤N.

In addition, in the case where there is the lower complex component 111c in the fault tree of the (N−1)th layer when configuring the fault tree of the Nth layer, the fault tree generation unit 120 arranges the simple component 111b or the lower complex component 111c included in the lower complex component 111c to the left and right on the lower side of the lower complex component 111c, and connects the simple component 111b or the lower complex component 111c to receive the failure information from the simple component 111b or the lower complex component 111c.

In this way, the layer flow diagram generation and the fault tree generation configuration using the layer concept may minimize and optimize the size of the fault tree by processing the fault tree configuration process more clearly, and minimize the possibility of errors when implementing automation.

In addition, as illustrated in FIG. 5, in the fault tree of the first layer of the serial structure, a fault tree composition item SYSTEM_FAIL corresponding to the output arrival point 111d is arranged at the top, a fault tree composition item INPUT_FAILURE corresponding to the input start point 111a is arranged at the left and right on the lower side, and fault tree composition items COMPLEX_COM1_FAILURE corresponding to the first complex component 111c are respectively arranged, and the output arrival point 111d receives failure information from these components through an OR gate.

This means that when only one of the components connected in series in the layer flow diagram fails, the upper component that receives failure information from these components receives the failure information through the OR gate.

Of course, in FIG. 5, the fault tree composition item is added before the output arrival point 111d to include functional failures and failures by causes other than functionality.

Accordingly, in FIG. 5, the functional failure items for the failure in the resource input, the failure of the first complex component, and the failure of the second complex component are received through the OR gate, and the output arrival point 111d generates the fault tree so that the functional failure items and the failure items by the causes other than the functionality are input through the OR gate.

Meanwhile, when decomposing the complex component 111c, since the plurality of simple components 111b or lower complex components 111c that constitute the complex component 111c are branched in parallel in the resource flow diagram and the layer flow diagram, each branch structure can be merged into a separate complex component 111c.

That is, the first complex component 111c in FIG. 3 is composed of a total of three branch flow lines, and two simple components 111b connected along the first branch flow line may be merged into one complex component 111c.

Accordingly, as illustrated in FIG. 6, among the three branch flow lines of the first complex component 111c, it can be displayed as a failure item of a first separation flow line, a failure item of a second branch flow line, and a failure item of a third branch flow line, and these are each input to the first complex component 111c through an AND gate.

When it is composed of only one simple component along each branch flow line, there is no need to configure it in the form of a complex component.

Therefore, in FIG. 7, an example of the configuration to receive OR gate input from the simple components on the lower side of the failure item of the first branch flow line is illustrated.

Of course, the failure items of the second branch flow line and the third branch flow line may also be displayed like the failure items of the first branch flow line.

However, even in this case, it goes without saying that the layer of the final fault tree has the second layer.

In this way, the item extraction unit 110 and the fault tree generation unit 120 according to an embodiment of the present invention generate the fault tree of the first layer in which the fault tree composition item 111 is connected in series along the flow line of the resource flow diagram, and when there is the complex component 111c among the fault tree composition items 111 constituting the fault tree of the first layer, generate the fault tree of the second layer by first decomposing the complex component 111c into the plurality of simple components 111b or lower complex components 111c branched.

In addition, when there is the lower complex component 111c among the fault tree composition items constituting the fault tree of the second layer, the fault tree of the Nth layer is generated by secondarily decomposing the lower complex component 111c into the configuration of the plurality of simple components or lower complex components branching along the flow line of the resource flow diagram but (N−1)-order decomposing the lower complex component until the fault tree composition item is composed of only the plurality of simple components.

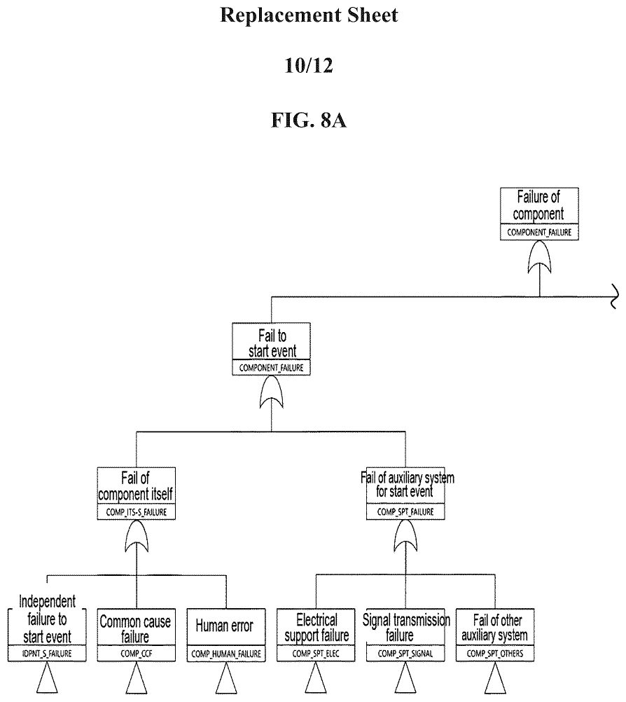

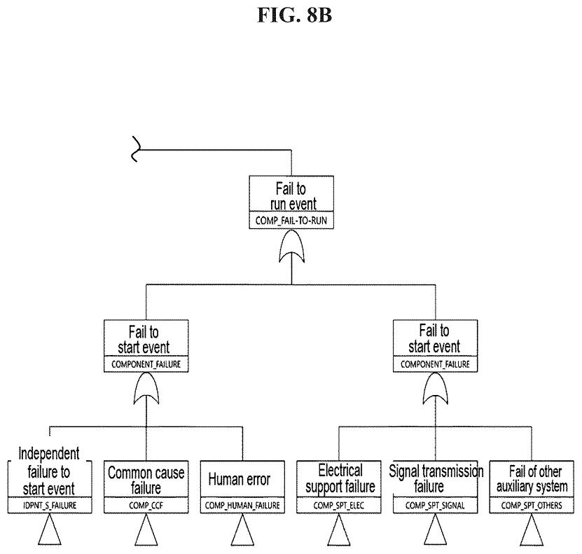

FIG. 8 is a diagram illustrating a fault tree of a simple component for each failure type and failure mode of a component according to another embodiment of the present invention.

Referring to the drawings, according to the present embodiment, the fault tree generation unit may classify the failure information of the fault tree composition item according to the failure mode and failure type, respectively, and connect the simple component to receive the failure information.

In the case of the system that forms the circular logic as the failure information is received according to these failure mode and failure type, the circular logic is fundamentally prevented from occurring within the fault tree.

In other words, since the cause items that constitute the circular logic are created as separate failure items according to the failure mode and the failure type to receive the failure information, the circular logic may be fundamentally blocked in the fault tree.

The failure information classification according to the failure mode and the failure type is shown in [Table 1] below.

TABLE 1

| | failure mode | |
|---|---|---|
| Failure type | Fail to start event | Fail to run event |
| Failure of component | Independent failure | Independent failure |
| itself | Common cause | Common cause |
| | failure | failure |
| | Human error | Human error |
| Auxiliary system | Cooling failure | Cooling failure |
| failure | Electrical support | Electrical support |
| (User definition) | failure | failure |
| | Signal transmission | Signal transmission |
| | failure | failure, error signal |
| | Others (according | Others (according |
| | to definition) | to definition) |

As shown in [Table 1] above, the failure information item according to the failure mode includes fail to start and fail to run events, and the failure information item according to the failure type includes failure of component itself and auxiliary system failure.

In addition, the failure information item according to the failure of the component itself includes at least one of independent failure, common cause failure, and human error, and the failure information according to the auxiliary system failure includes at least one of cooling failure, power supply failure, signal transmission failure, and the failure information according to user settings.

Here, the administrator may add failure information items according to user settings through the input unit 200 or a separate interface.

In addition, since the failure information items in [Table 1] for the above components are all OR relationships of Boolean algebra, this may be expressed as a fault tree as shown in FIG. 8.

When the fault tree is created in this way, it may be written in a standard form for all components, errors when generating the fault tree may be reduced as much as possible, and, as described above, the occurrence of the circular logic may be fundamentally blocked.

The failure information according to the auxiliary system failure may be expressed as examples of cooling failure, electrical support failure, etc., as each component may have one or more auxiliary systems to perform its function, as shown in [Table 1] above.

By including the failure information item of the auxiliary system, an independent fault tree using the resource flow diagram may be configured, and as illustrated in FIG. 8, the fault tree of the auxiliary system may be generated along with the failure of the component itself.

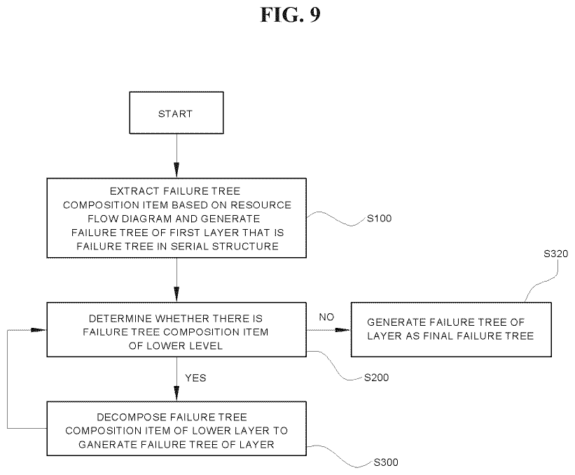

FIG. 9 is a flowchart illustrating a method for generating a fault tree according to an embodiment of the present invention.

Referring to the drawings, the method for generating a fault tree according to an embodiment of the present invention largely includes, by the controller 100, extracting the fault tree composition items including the input start point, the output arrival point, the simple component, and the complex component based on the received resource flow diagram, and generating the fault tree of the first layer, which is the fault tree of the serial structure (S100), determining whether there is a fault tree composition item in a lower-layer layer (S200), and when there is the fault tree composition item of the lower layer, decomposing the fault tree composition item to generate a fault tree of the layer, and returning to S200 above, and when there is no fault tree composition item of the lower layer, generating the fault tree of the corresponding layer as the final fault tree (S300).

Here, in step S100, as described in the above-described fault tree generating device, the fault tree composition items are extracted according to the layer based on the resource flow diagram received by the control unit 100, and the fault trees of the first layer connecting the fault tree composition items in the form of the first layer is generated.

Accordingly, when the fault tree of the first layer is generated, it is determined whether there is the complex component 111c with the second layer among the fault trees of the first layer (S200), if so, the complex component 111c is decomposed to generate the fault tree of the second layer, and the process returns to step S200 (S310). If not, the fault tree of the first layer is confirmed as the final fault tree and the process ends (S320).

Of course, when the fault tree of the second layer is generated and the process returns to step S200, the above-described process is repeated by determining whether there is the complex component 111c with the next layer, and the process is repeated until only the simple component 111b is displayed without the complex component 111c.

Here, the complex component 111c includes the plurality of simple components 111b or lower complex components 111c that are branched and configured along the flow line of the resource flow diagram as described above, and the lower complex component 111c is included as the fault tree composition item 111 in the upper complex component 111c, and the plurality of simple components 111b or lower complex components 111c are included as the fault tree composition item 111 therein.

The lower or upper part refers to the height of the layer. The lower part refers to a layer that increases or decreases 1 from the corresponding layer, and the upper part refers to a layer that subtracts 1 from the corresponding layer.

In addition, the control unit 100 includes an item extraction unit 110 that extracts the fault tree composition items 111 for each layer based on the resource flow diagram received as described above, and a fault tree generation unit 120 that sequentially generates the fault trees for each layer based on the resource flow diagram and the fault tree composition items 111 for each layer to generate the final fault tree.

Since the fault tree generating device is described above, separate detailed description will be omitted.

The present invention has industrial applicability in that it relates to the fault tree generating device that generates a final fault tree by extracting fault tree composition items for each layer along a flow line of a resource flow diagram to sequentially generate the fault tree according to the layer.

Although exemplary embodiments of the present disclosure have been described hereinabove, the present disclosure is not limited to the above-mentioned specific exemplary embodiments. That is, many modifications and alterations of the present disclosure may be made by those skilled in the art to which the present disclosure pertains without departing from the spirit and scope of the accompanying claims. In addition, it is to be considered that all of these modifications and alterations fall within the scope of the present disclosure.

[Detailed Description of Main Elements]

| | |
|---|---|
| 100: Control unit | |
| 110: Item extraction unit | |
| 111: Fault tree composition item | 111a: Input start point |
| 111b: Simple component | 111c: Complex component |
| 111d: Output arrival point | 112: Node |
| 112a: First layer node | 112b: Second layer node |
| 120: Fault tree generation unit | |
| 200: Input unit | |
| 300: Output unit | |
| 1000: Fault tree generating device | |

What is claimed is:

1. A fault tree generating device that generates a fault tree based on a resource flow diagram composed of a plurality of components, comprising:
a control unit that generates a final fault tree by extracting fault tree composition items including an input start point, an output arrival point, a simple component, and a complex component based on the received resource flow diagram, and connecting the fault tree composition items according to a layer to sequentially generate fault trees.

2. The fault tree generating device of claim 1, wherein the control unit generates a fault tree of a first layer in which the fault tree composition items are connected in series along the flow line of the resource flow diagram, and
generates a fault tree of a second layer by primarily decomposing the complex component into a configuration of a plurality of simple components or lower complex components branched when there is the composite component among the fault tree composition items constituting the fault tree of the first layer.

3. The fault tree generating device of claim 2, wherein when there is the lower complex component among the fault tree composition items constituting the fault tree of the second layer, the control unit generates a fault tree of an Nth layer by secondarily decomposing the lower complex component into the configuration of the plurality of simple components or lower complex components branching along the flow line of the resource flow diagram but (N−1)-order decomposing the lower complex component until the fault tree composition item is composed of only the plurality of simple components.
(Here, N is a natural number, and 3≤N.)

4. The fault tree generating device of claim 3, wherein the control unit includes:
an item extraction unit that extracts the fault tree composition items for each layer based on the received resource flow diagram; and
a fault tree generation unit that generates the final fault tree by sequentially generating fault trees for each layer based on the resource flow diagram and the fault tree composition items for each layer.

5. The fault tree generating device of claim 4, wherein the complex component includes the plurality of simple components or lower complex components branched and configured along the flow line of the resource flow diagram, and
the lower complex component is included as a fault tree composition item in an upper complex component, and the plurality of simple components or lower complex components are included as a fault tree composition item therein.

6. The fault tree generating device of claim 5, wherein the fault tree generation unit arranges the output arrival point, which is the last point reached along the flow line of the resource flow diagram, at a top when configuring the fault tree of the first layer,
arranges the input start point, which is the start point on the flow line of the resource flow diagram and the simple component or the complex component connected in series to be spaced apart from each other to left and right on a lower side of the output arrival point, respectively, and
connects the simple component or the complex component so that the output arrival point receives failure information from the input start point, the simple component, or the complex components.

7. The fault tree generating device of claim 6, wherein in the case where there is the complex component in the fault tree of the first layer when configuring the fault tree of the second layer, the fault tree generation unit arranges the simple component or the lower complex component included in the complex component to the left and right on the lower side of the complex component, and connects the simple component or the lower complex component to receive the failure information from the simple component or the lower complex component.

8. The fault tree generating device of claim 7, wherein in the case where there is the lower complex component in the fault tree of the (N−1)th layer when configuring the fault tree of the Nth layer, the fault tree generation unit arranges the simple component or the lower complex component included in the lower complex component to the left and right on the lower side of the lower complex component, and connects the simple component or the lower complex component to receive the failure information from the simple component or the lower complex component.
(Here, N is a natural number, and 3≤N.)

9. The fault tree generating device of claim 4, wherein the item extraction unit generates a layer flow diagram that sequentially displays the fault tree composition items according to the layer based on the resource flow diagram, and
the fault tree generation unit sequentially generates fault trees for each layer based on the layer flow diagram.

10. The fault tree generating device of claim 9, wherein the item extraction unit displays nodes for each layer between the fault tree composition items for each layer in the layer flow diagram.

11. The fault tree generating device of claim 8, wherein the fault tree generation unit classifies the failure information of the fault tree composition item, respectively, according to the failure mode and failure type and connects the simple component to receive the failure information,
the failure information according to the failure mode includes at least one of a fail to start event and a fail to run event, and
the failure information according to the failure type includes at least one of failure of component itself and auxiliary system failure.

12. The fault tree generating device of claim 11, wherein the failure information due to the failure of the component itself includes at least one of independent failure, common cause failure, and human error, and
the failure information according to the auxiliary system failure includes at least one of cooling failure, electrical support failure, signal transmission failure, and other failure information according to user setting.

13. A method for generating a fault tree using a fault tree generating device having the characteristics of claim 1, the method comprising: by the control unit,
a) extracting the fault tree composition items including the input start point, the output arrival point, the simple component, and the complex component based on the received resource flow diagram, and generating the fault tree of the first layer, which is the fault tree of the serial structure;
b) determining whether there is a fault tree composition item in a lower layer; and
c) when there is the fault tree composition item of the lower layer, decomposing the fault tree composition item to generate a fault tree of the layer, and returning to step b) above, and when there is no fault tree composition item of the lower layer, generating the fault tree of the corresponding layer as the final fault tree.

14. The method of claim 13, wherein the complex component includes the plurality of simple components or lower complex components branched and configured along the flow line of the resource flow diagram, and
the lower complex component is included as a fault tree composition item in an upper complex component, and the plurality of simple components or lower complex components are included as a fault tree composition item therein.

15. The method of claim 13, wherein the control unit includes:
an item extraction unit that extracts the fault tree composition items for each layer based on the received resource flow diagram; and
a fault tree generation unit that generates the final fault tree by sequentially generating fault trees for each layer based on the resource flow diagram and the fault tree composition items for each layer.
